(19) United States
(12) Patent Application Publication
(10) Pub. No.: US 2006/0220910 A1
(43) Pub. Date: Oct. 5, 2006

(54) Parking aid for a vehicle

(76) Inventors: Guido Becker, Losheim am See (DE); Marta Castillo Franco, Bascharage (LU); Bruno Mirbach, Konz (DE); Thierry Mousel, Mondorf (LU); Marc Schifflers, Tubis (LU)

Correspondence Address: CANTOR COLBURN, LLP, 55 GRIFFIN ROAD SOUTH, BLOOMFIELD, CT, 06002, US

(21) Appl. No.: 10/552,788

(22) PCT Filed: Apr. 8, 2004
(86) PCT No.: PCT/EP04/50494

§ 371 Date: Oct. 10, 2005

(30) Foreign Application Priority Data
Apr. 10, 2003 (EP) 03100962.4

(51) Int. Cl. G01S 17/89; G08G 1/14

(52) U.S. Cl. 340/932.2; 701/96

(57) ABSTRACT

A method for providing parking aid for a vehicle, comprises the steps recording ambient data in the external area of a vehicle, calculation of the dimensions of a specific area using the recorded ambient data, and evaluation of the suitability of the specific area as a parking space taking into account the calculated dimensions and known, vehicle-specific reference values. According to the invention, the recording of ambient data comprises recording three-dimensional images of the surroundings by means of an optical 3-D system.

### INTRODUCTION

The present invention relates to a parking aid for a vehicle. In order to facilitate driving the motor vehicle and to prevent collisions with vehicles or other objects in the way it is known to provide sensors on the front and/or rear of the motor vehicle, which sensors emit, for example, ultrasonic signals or radar signals and receive again the signals which have been reflected by the obstacle. The distance between the sensor which is arranged on the motor vehicle and the obstacle is determined here from the propagation time of the signal from the sensor to the obstacle and back again. Such a system is known, for example, from EP-A-0 984 300. Such systems are capable of transmitting information about the distance from an obstacle arranged behind the vehicle to the driver, for example when the vehicle is reset. However, such systems cannot provide any help in estimating the suitability of a parking space before the vehicle drives into it.

The German patent application DE-A-38 44 340 describes a device for determining the dimensions of a parking space. The device which is proposed in this document comprises a plurality of sensors (ultrasonic, infrared or microwave transmitters and receivers) which are mounted on the motor vehicle and which survey the geometric position of the parking space with respect to the motor vehicle. The dimensions of the parking space are determined by trigonometric calculation methods or by differences in propagation time between the optical or audible signals.

The document DE-A-100 45 616 describes a method for automatically parking a vehicle in which the surrounding area to the front and laterally to the front of the vehicle is recorded by means of a video camera. This recorded real image is converted into a plan view by means of suitable evaluation methods and said plan view is presented to the driver on a screen. The driver can then use this plan view to detect a parking space at an early point and select it for parking. A control system of the vehicle then causes the vehicle to be moved into an initial position which is optimum for the automatic parking and the parking process can occur in a known fashion with the aid of distance sensors. A problem with this device is that the image which is recorded by the video camera has to be analyzed using complex image processing methods in order to obtain depth information relating to the free parking space. In order to obtain reliable depth information about the available free depth of the parking space, the recorded image must in fact be separated computationally into an image foreground which is of interest and an image background which is not relevant. This processing of the recorded images is, however, very intensive in terms of computing and accordingly requires correspondingly more expensive hardware equipment of the system.

### OBJECT OF THE INVENTION

The object of the present invention is consequently to propose a better method for providing parking aid and a corresponding device.

### GENERAL DESCRIPTION OF THE INVENTION

This object is achieved according to the invention by means of a method as claimed in claim 1 and a device as claimed in claim 10 of the present application.

A method for providing parking aid for a vehicle, comprises the steps recording ambient data in the external area of a vehicle, calculating the dimensions of a specific area using the recorded ambient data, and evaluating the suitability of the specific area as a parking space taking into account the calculated dimensions and known, vehicle-specific reference values. According to the invention, the recording of ambient data comprises recording three-dimensional images of the surroundings by means of an optical 3-D system.

Accordingly, a device for providing parking aid for a vehicle comprises a sensor device for recording ambient data in the external area of a vehicle, and an evaluation device for calculating the dimensions of a specific area on the basis of the recorded ambient data and for evaluating the suitability of the specific area as a parking space on the basis of the calculated dimensions and known, vehicle-specific reference values. According to the present invention, such a system is distinguished by the fact that the sensor device comprises an optical 3-D sensor system for recording three-dimensional images of the surroundings.

An optical three-dimensional system such as, for example, a 3-D camera, supplies both a two-dimensional image of the surrounding area and at the same time depth information about the recorded image. The depth information is determined, for example, with a propagation time method, with the time period between the emission of a light pulse and the arrival of a reflected light pulse being determined and converted into a distance between the sensor system and the reflective object. Accordingly, such a system directly supplies all the necessary data for evaluating the dimensions of the space which is available for parking. It is therefore possible to eliminate the need for complex processing for the purpose of detection and, if appropriate, for eliminating a destructive background. In fact, with the 3-D sensor system a background which is not of interest is eliminated directly by restricting the depth of the external area of the vehicle which is to be recorded during the actual recording of the ambient data. As a result, the computational complexity for evaluating the image is considerably reduced so that a system which operates according to the proposed method requires comparatively modest and accordingly favorable hardware equipment.

In one possible refinement of the method, the recording of ambient data comprises recording a situation image of the entire area of interest, i.e. a possible parking space is recorded completely by the optical 3-D sensor system. This method can be carried out either while the vehicle passes by the potential parking space or from the stationary vehicle when the latter stops, for example, in the direct vicinity of the potential parking space. For such close range observation, which may be carried out, for example, by means of a wide angle lens, a single image recording is sufficient in order to register all the relevant properties of the potential parking space. The optical 3-D sensor comprises a large number of pixels, each of which detects the distance from possible objects in its field of vision. As a result, the sensor directly supplies topographical information about the external area of the vehicle within the measuring range. The evaluation of images can consequently be restricted to the evaluation of an individual situation image with this method, as a result of which the processing complexity for the evaluation of images is minimized.

In another embodiment of the method, the recording of ambient data comprises the successive recording of adjacent component images of the area of interest, i.e. the area of interest is scanned by the 3-D sensor system. In this embodiment, the area of interest is divided into a plurality of narrow component areas which are successively recorded by the sensor system and then evaluated together in order to determine the dimensions of the parking space. Since the individual component images contain comparatively less information, in contrast to an entire situation image of the parking space, in this embodiment of the method the number of pixels of the sensor system can be reduced without the overall resolution of the device being degraded. This means that the sensor system is correspondingly more cost effective. When a sensor system with a large number of pixels is used, it is alternatively possible to increase the resolution of the system with such a method so that possible obstacles are detected better.

It is to be noted that with the proposed variant of the method according to the invention each component image generally contains all the depth information related to the recorded component area. In order to determine the length of the potential parking space, it is necessary, in addition to the recorded component images, to determine the scanning speed in order to be able to create a topographical image of the specific area. The proposed embodiment of the method is used, for example, while the vehicle drives past the potential parking space with the instantaneous velocity of the vehicle being determined as it drives past and being taken into account as a scanning speed during the evaluation of the individual component images. The individual, successively recorded component images of the area of interest can then be correlated with one another by means of a determined Vehicle velocity. Alternatively, the 3-D sensor system can be arranged in a pivotable fashion so that the area of interest can be scanned by pivoting the sensor system even on a stationary vehicle.

As has already been described above, an optical 3-D sensor system is highly suitable for determining the dimensions of a specific area on the basis of the directly determined distance data from individual image information items. Furthermore, each obstacle which is located within the measuring range of the sensor system can be located with high accuracy using the distance information which is also supplied. In an advantageous embodiment of the invention, the latter property is used in order to detect an obstacle in the specific area on the basis of the recorded surroundings. In this context it is even possible, by means of a suitable configuration of the sensor system, to determine whether the obstacle is an immobile obstacle, which generally rules out using the specific area as a parking space, or whether the obstacle is mobile, which does not necessarily rule out the use as a parking space.

By means of the determined dimensions of the potential parking space and known, vehicle-specific reference values it is possible for the evaluation unit to evaluate whether the vehicle fits into the potential parking space. If this evaluation is carried out, the result thereof can be signaled to the driver of the vehicle as an instruction to attempt the parking operation or abort it and drive to another parking space. For this purpose, the evaluation device is preferably coupled to an information system for outputting a result of the evaluation step to a driver of the vehicle. The result can be output, for example, optically on a screen which is arranged in the passenger compartment of the vehicle. Alternatively or additionally, the result can be displayed optically by means of flashing signal lights on the dashboard and/or conveyed audibly as a signal tone or as a voice output and/or mechanically, for example by vibration of the steering wheel.

It is to be noted that the position of a parking space With respect to the Vehicle can be determined using the recorded ambient data. This determination of position can be carried out at low cost in addition to the calculation of the dimensions of the specific area. If the evaluation device is coupled to a control system for an automatic parking system (sensor fusion), the determined dimension and position data can be transmitted to this control system and used for the automatic parking process.

In one preferred embodiment, the sensor device operates in the infrared range. The optical 3-D sensor system then advantageously comprises a pulsed infrared lighting source and an image sensor which is sensitive in the infrared range, for the purpose of recording the light pulses which are reflected in the external area of the vehicle.

It is to be noted that the optical 3-D sensor system is preferably mounted on the vehicle, in the external area of the vehicle. A suitable position on the vehicle is, for example, the exterior mirror on the front seat passenger side of the vehicle. Alternatively, the sensor system can be arranged in the vehicle in such a way that it looks outward. Possible installation locations are, for example, mudguards or A, B or C pillars of the vehicle. The sensor system or the entire parking aid system can preferably be activated by the driver when necessary with the system possibly being active only under a predetermined limiting velocity.

### DETAILED DESCRIPTION WITH REFERENCE TO THE FIGURES

An embodiment of the invention will be described below with reference to the appended figures, in which:

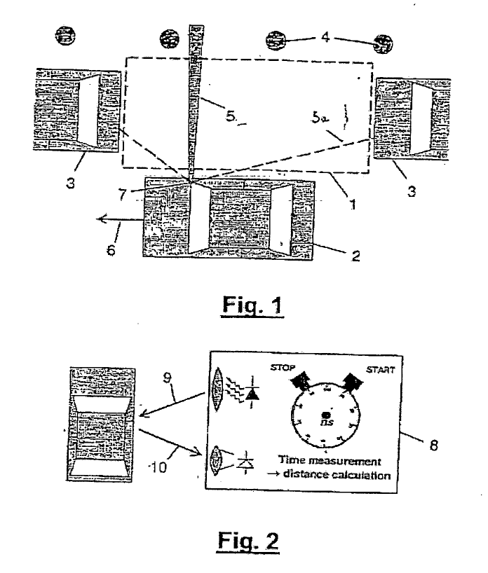

FIG. 1: is a schematic plan view of a possible parking situation for a passenger vehicle;

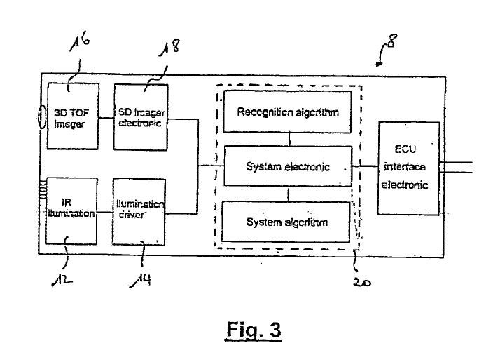

FIG. 2: is a schematic illustration of the algorithm of a propagation time method (Time of Flight);

FIG. 3: is a block diagram of a 3-D sensor system.

The object of the present invention is to detect free parking spaces which are suitable for the vehicle on which the system is mounted. The detection can take place either on a stationary vehicle or on a vehicle which is driving by.

FIG. 1 shows a typical parking situation. The vehicle 2 drives along a road. The edge of the road is bounded by vertical obstacles 4, for example trees on a sidewalk. Two further vehicles 3 are parked along the sidewalk and a parking space 1 can be seen between said vehicles 3.

The driver of vehicle 2 would like to use this parking space. To do this, he must firstly estimate whether the dimensions of the parking space 1 are sufficient to permit the vehicle 2 to be parked, of course without touching the vehicles 3. This evaluation of the parking space is preferably carried out according to a method corresponding to the present invention.

In the illustrated embodiment of the method, the dimensions of the parking space are determined while the vehicle 2 is driving past the parking space 1. To do this, an optical 3-D sensor system which is arranged on a front-passenger-seat-side external area, for example on the exterior mirror 7, of the vehicle records in succession various adjacent component images of the parking space. Each of the component images comprises all the topographical information from the respectively recorded, narrow area 5 of the parking space 1. This means that the parking space 1 is scanned by the 3-D sensor system as the vehicle 2 drives past. Each of the component images can be evaluated separately per se in order to detect a possible obstacle in the respective component area of the parking space. The length of the available parking space 1 can be determined by reference to the vehicle velocity, and if appropriate, the scanning frequency of the 3-D sensor system by calculating the driving distance between two component areas in which an obstacle has been detected. It is to be noted that the individual component images can also be combined to form one composite image of the parking space if this were to be necessary for further image evaluation.

The depth of the measuring range 5 is preferably set in such a way that the 3-D sensor system processes only the information which is necessary for determining the dimensions of the parking space. In the embodiment shown, the depth is set, for example, in such a way that the measuring range extends only insignificantly beyond a rear boundary, for example the edge of a kerb stone. In this way, obstacles in the direct vicinity of the edge of the kerb stone which constitute a real hazard when parking can still be effectively detected while a pedestrian who is standing on the sidewalk is outside the measuring range. The measuring depth is preferably set automatically after a rear boundary of the parking space, for example the edge of a kerb stone, is sensed and its distance from the sensor system determined.

In one alternative embodiment of the method, instead of component images of the parking space a situation image of the entire parking space is recorded with the sensor system. If the vehicle 2 stops, for example directly next to the parking space 1, the 3-D sensor system can record a three-dimensional situation image of the parking space 1 (measuring range 5a, represented by dashed lines in FIG. 1) using a wide angle lens. In this context the 3-D sensor system supplies topographical information about the existing parking space, that is to say information about the height, width and depth of the parking space 1 is sensed directly by the sensor system. The situation image, and the topographical image which is contained in it and which relates to the parking space, is then processed by the evaluation unit (not illustrated) in order to determine the dimensions of the free parking space and evaluate the suitability of the parking space for the vehicle 2.

If the evaluation of the suitability of the parking space is detected, that is to say if the length and the depth of the parking space 1 permit parking, for example an optical or audible enabling signal can be transmitted to the driver of the vehicle 2.

FIG. 2 illustrates the propagation time method which can be used to determine the depth of an image by means of a 3-D sensor system 8. The period of time, illustrated by the stop watch, between the emission of a light pulse 9 and the reception of a reflected light pulse 10 is determined. This period of time is then converted into a distance between the 3-D sensor system and the reflected object. In addition to the actual two-dimensional image information it is possible to use this method to simultaneously determine depth information for each pixel of the sensor system. In this way the topographical image of the parking space is produced.

FIG. 3 shows a block diagram of a 3-D sensor system 8. The latter comprises essentially a lighting unit with a light source 12 and an assigned ballast device 14 as well as an image recording unit with an image sensor 16 with associated driver circuit 18. The light source is preferably an infrared light source so that the light which is emitted by it is not disruptive to people.

The lighting unit and the image recording unit are connected to an electronic control and evaluation device 20 which coordinates the functions of the two units and processes the recorded situation images.

### LIST OF REFERENCE NUMERALS

1 Parking space
2 Vehicle
3 Parked vehicles
4 Obstacles
5, 5a Measuring range of the sensor system
6 Direction of travel of the vehicle 2
7 Exterior mirror of the vehicle
8 Sensor system
9, 10 Light paths during propagation time measurement
12 Light source
14 Ballast device
16 Image sensor
18 Driver circuit
20 Electronic control and evaluation device

1.-16. (canceled)

17. A method for providing parking aid for a vehicle, comprising:
recording of ambient data in an external area of a vehicle,
calculation of dimensions of a specific area using the recorded ambient data, and p1 evaluation of a suitability of the specific area as a parking space taking into account the calculated dimensions and known, vehicle-specific reference values,
wherein the recording of ambient data comprises recording three-dimensional images of surroundings by means of an optical 3-D system.

18. The method as claimed in claim 17, wherein said optical 3-D system comprises a 3-D camera.

19. The method as claimed in claim 17, wherein the recording of ambient data comprises the recording a situation image of the entire area of interest.

20. The method as claimed in claim 17, wherein the recording of ambient data comprises the successive recording of adjacent component images of the area of interest.

21. The method as claimed in claim 17, wherein a topographical image of the specific area is created on the basis of the recorded ambient data.

22. The method as claimed in claim 17, wherein an obstacle in the specific region is detected on the basis of the recorded surroundings.

23. The method as claimed in claim 17, wherein a result of the evaluation step is signaled to a driver of the vehicle.

24. The method as claimed in claim 17, wherein, in addition to the calculation of the dimensions of the specific area, the position of the specific area with respect to the vehicle is determined on the basis of the recorded ambient data.

25. The method as claimed in claim 24, wherein the calculated dimensions and position of the specific area are transmitted to a control system for an automatic parking system.

26. A device for providing parking aid for a vehicle, comprising a sensor device for recording ambient data in an external area of a vehicle, and
an evaluation device for calculating dimensions of a specific area on a basis of the recorded ambient data and for evaluating a suitability of the specific area as a parking space on a basis of the calculated dimensions and known, vehicle-specific reference values,
wherein the sensor device comprises an optical 3-D sensor system for recording three-dimensional images of surroundings.

27. The device as claimed in claim 26, wherein the optical 3-D system comprises a 3-D camera.

28. The device according to claim 26, wherein the evaluation circuit determines the dimensions of the specific area on the basis of a situation image of the entire area of interest.

29. The device as claimed in claim 26, wherein the evaluation circuit determines the dimensions of the specific area on the basis of a plurality of successively recorded component images of the area of interest, wherein the various component images are correlated with one another by way of a determined vehicle velocity.

30. The device as claimed in claim 26, wherein the sensor device operates in the infrared range.

31. The device as claimed in claim 26, wherein the evaluation device is coupled to an information system for outputting a result of the evaluation step to a driver of the vehicle.

32. The device as claimed in claim 26, wherein the evaluation unit has means for determining the position of the specific area with respect to the vehicle.

33. The device as claimed in claim 31, wherein the evaluation device is coupled to a control system for an automatic parking system in order to transmit dimension data and position data of the specific area.

34. The device as claimed in claim 26, wherein the optical 3-D sensor system is mounted on the vehicle, in the external area of the vehicle.

35. A method for providing parking aid for a vehicle, comprising
recording of ambient data in an external area of a vehicle,
calculation of dimensions of a specific area using the recorded ambient data, and
evaluation of a suitability of the specific area as a parking space taking into account the calculated dimensions and known, vehicle-specific reference values,
wherein the recording of ambient data comprises recording three-dimensional images of surroundings by means of an optical 3-D camera.

36. The method as claimed in claim 35, wherein the recording of ambient data comprises the recording a situation image of the entire area of interest.

37. The method as claimed in claim 35, wherein the recording of ambient data comprises the successive recording of adjacent component images of the area of interest.

38. The method as claimed in claim 35, wherein a topographical image of the specific area is created on the basis of the recorded ambient data.

39. The method as claimed in claim 35, wherein an obstacle in the specific region is detected on the basis of the recorded surroundings.

40. The method as claimed in claim 35, wherein a result of the evaluation step is signaled to a driver of the vehicle.

41. The method as claimed in claim 35, wherein, in addition to the calculation of the dimensions of the specific area, the position of the specific area with respect to the vehicle is determined on the basis of the recorded ambient data.

42. The method as claimed in claim 41, wherein the calculated dimensions and position of the specific area are transmitted to a control system for an automatic parking system.

43. A device for providing parking aid for a vehicle, comprising a sensor device for recording ambient data in an external area of a vehicle, and
an evaluation device for calculating dimensions of a specific area on a basis of the recorded ambient data and for evaluating a suitability of the specific area as a parking space on a basis of the calculated dimensions and known, vehicle-specific reference values,
wherein the sensor device comprises an optical 3-D camera for recording three-dimensional images of surroundings.

44. The device according to claim 43, wherein the evaluation circuit determines the dimensions of the specific area on the basis of a situation image of the entire area of interest.

45. The device as claimed in claim 43, wherein the evaluation circuit determines the dimensions of the specific area on the basis of a plurality of successively recorded component images of the area of interest, wherein the various component images are correlated with one another by way of a determined vehicle velocity.

46. The device as claimed in claim 43, wherein the sensor device operates in the infrared range.

47. The device as claimed in claim 43, wherein the evaluation device is coupled to an information system for outputting a result of the evaluation step to a driver of the vehicle.

48. The device as claimed in claim 43, wherein the evaluation unit has means for determining the position of the specific area with respect to the vehicle.

49. The device as claimed in claim 47, wherein the evaluation device is coupled to a control system for an automatic parking system in order to transmit dimension data and position data of the specific area.

50. The device as claimed in claim 43, wherein the optical 3-D sensor system is mounted on the vehicle, in the external area of the vehicle.
